(19) United States
(12) Patent Application Publication
(10) Pub. No.: US 2021/0078196 A1
(43) Pub. Date: Mar. 18, 2021

(54) SAW

(71) Applicant: BLACK & DECKER INC., New Britain, CT (US)

(72) Inventor: Spinelli Pierluigi, Perugia (IT)

(21) Appl. No.: 16/728,210

(22) Filed: Dec. 27, 2019

(30) Foreign Application Priority Data
Sep. 16, 2019 (GB) 1913317.2

(51) Int. Cl. B27B 27/08; B23D 45/04

(52) U.S. Cl. CPC B27B 27/08; B23D 45/046

(57) ABSTRACT

A saw with a base assembly, a saw assembly pivotally mounted on the base assembly which is capable of pivoting towards the base assembly to a cut a work piece located on the base assembly, and a fence assembly extending across at least part of the base assembly. The fence assembly has a fence base, a fence plate slidingly mounted on the fence base, and a moveable stop mounted on the fence plate which is capable of being moved between two positions.

### FIELD

The present invention relates to chop saws and in particular to chop saws with a movable fence against which a work piece is placed during a cutting operation.

### BACKGROUND

Chop saws typically have a motor unit pivotally mounted on a base. The motor unit is typically located above the base and can pivot between a high position where it is located further most away from the base to a low position where a circular saw blade, which is mounted on the motor unit and which is capable of being rotationally driven by a motor located within the motor unit, can engage with a work piece located on the base. A spring biases the motor unit to its upper most position.

Furthermore, these types of saws include mechanisms by which they are able to perform miter and bevel cuts on work pieces located on the base.

Sliding compound miter saws have an additional sliding feature wherein the motor unit, in addition to be able to perform a pivotal or chopping movement, can slide linearly across the base to perform a slide cut.

These types of saws include a fence which traverses the base. During the operation of the saw, a work piece is placed against the fence to maintain its position whilst it is being cut.

These types of saws typically include guards which surround the edge of the saw blade. Typically, a fixed guard surrounds the cutting edge of the top half of the cutting blade, while a pivotal guard surrounds the cutting edge of the lower half of the cutting blade. The pivotal guard is capable of being pivoted from a first position where it surrounds the cutting edge of the lower half of the cutting blade to a retracted position where the cutting edge of the lower half of the cutting blade is exposed so that the cutting blade can be used to cut a work piece.

EP1772221 describes one example of a design of a sliding compound miter saw. Referring to FIG. 1, the saw described in EP177221 comprises a base 2 in which is mounted a circular table 4. The circular table 4 can rotate about a vertical axis. An arm 6 is attached to the front of the circular table 4 which extends through a recess 8 formed in the front of the base 2 and then forward of the base 2. As the circular table rotates, the arm 6 swings within the recess 8, the maximum amount of pivotal movement being limited by the sides 10 of the recess 8. A latch 12 is attached to the underside of the end of the arm 6 which is capable of releasably locking the angular position of the arm 6 within the recess 8. A fence 14 is rigidly attached to the base 2 and passes over the circular table 4.

Pivotally attached to the rear of the circular table 4 is a bevel support 16. The bevel support 16 can pivot about a horizontal bevel axis 18. The bevel support 16 can be locked in a range of angular positions relative to the circular table 4 using a locking handle 20.

Pivotally mounted onto the bevel support 16 is a slide support 22. The slide support 22 can pivot about a chopping axis 24 which is parallel to the axis of rotation 26 of a cutting blade 128.

Rigidly mounted within the slide support 22 are the ends of two straight rods 30; 32. The rods 30, 32 are prevented from sliding or rotating within the slide support 22. The rods 30, 32 are located one above the other and are parallel to each other. Attached to the end 34 of the top rod 30 is a spring 36. The other end of the spring 36 is attached to the bevel support 16. The spring 36 is under tension, biasing the end 34 of the top rod 30 downwardly, biasing the ends of the two rods 30, 32 located remotely from the slide support 22 upwardly due to the pivotal connection of the slide support 22 to the bevel support 16.

Slideably mounted onto the two rods 30, 32 is a saw assembly 138. The saw assembly 138 comprises a motor housing 40 in which is mounted an electric motor. The electric motor is powered via an electric cable 42. Mounted on the front of the motor housing 40 is a handle 44. A trigger switch 46 is mounted within the handle 44, which when depressed, activates the motor. A drive spindle 48 projects from the housing 40. A circular saw blade 128 is rigidly mounted onto the drive spindle 48. When the motor, is activated, the drive spindle rotates, rotatingly driving the saw blade 128. A fixed guard 52 is rigidly mounted onto the motor housing 40 and surrounds the top cutting edge of the saw blade 128. A pivotal guard 54 is pivotally mounted on the motor housing 40 and can pivot about the axis of rotation 26 of the saw blade 128. The pivotal guard 54 can pivot between an enclosed position where it surrounds the lower cutting edge of the saw blade 128 and a retracted position where it exposes the lower cutting edge of the saw blade 128. When the pivotal guard is in the retracted position, it is telescopically pivoted into the fixed guard 52. A pivotal guard spring biases the pivotal guard 54 to the enclosed position.

The saw assembly 138 can slide along the two rods 30, 32 towards or away from the slide support 22.

In use, a work piece is placed on the base 2 and circular table 4 against the fence 14. The pivotal movement of the circular table 4 about the vertical axis allows the saw to perform miter cuts on the work piece. The pivotal movement of the bevel support 16 in relation to the circular table 4 about the bevel axis 18 allows the saw to perform bevel cuts on the work piece. The pivotal movement of the slide support 22 on the bevel support 16 about the chopping axis 24 allows the saw to perform chop cuts on the work piece. The sliding movement of the saw assembly 138 along the two rods 30, 32 allows the saw to perform sliding cuts on the work piece.

The saw has a pivotal guard actuating mechanism. The pivotal guard actuating mechanism causes the pivotal guard to pivot to its retracted position when the saw assembly 138 is pivoted about the chopping axis 24 from its upper position to its lower position. The spring 36 biases the saw assembly 138 to pivot about the chopping axis 24 to its upper most position. In this position, the pivotal guard 54 encloses the lower edge of the cutting blade 128. As the saw assembly 138 is pivoted downwardly towards the circular table 4, the pivotal guard actuating mechanism causes the guard 54 to retract into the fixed guard 52, exposing the lower cutting edge of the blade 128.

Often in these types of saw, the fence comprises a stationary fence mounted on the base with a moveable fence mounted on a base or a stationary fence (with their support surfaces for the work piece being aligned). The position of the stationary fence remains fixed. The moveable fence typically slides along the top of the base or the stationary fence, in a lengthwise direction, towards or away from the blade (when it is in its lowest position) so that its position can be adjusted relative to the blade.

U.S. Pat. No. 5,297,463 discloses a compound miter saw with a table top which has a sliding fence 24 mounted on a fixed fence 26. EP1813400 discloses a sliding compound miter saw with a table top which has a sliding fence 620 mounted on a fixed fence 608.

### DESCRIPTION OF DRAWINGS

FIG. 1 shows a perspective view of a prior art design of saw as disclosed in EP1772221;

FIG. 2 shows a front view of the sliding fence with the flip down stop in its first forward position;

FIG. 3 shows a front perspective view of the sliding fence with the flip down stop in its first forward position;

FIG. 4 shows a front perspective view of the sliding fence with the flip down stop in its second rearward position;

FIG. 5 shows a side view of the sliding fence with the flip down stop in its second rearward position;

FIG. 6 shows a second front perspective view of the sliding fence with the flip down stop in its first forward position and the fence moved to an inward position;

FIG. 7 shows a side view of the sliding fence with the flip down stop in its first forward position;

FIG. 8 shows a side view of the lock knob and retaining clip for the sliding fence;

FIG. 9 shows a perspective view of the lock knob and retaining clip mounted on the fence base;

FIG. 10 shows a horizontal cross-sectional view of the lock knob and retaining clip mounted on the fence base;

FIG. 11 shows a vertical cross-sectional view of the lock knob and retaining clip mounted on the fence base;

FIG. 12 shows a rubber ring;

FIG. 13 shows a wrench mounted in the rubber ring on the base;

FIG. 14 is sketch of a workpiece located on the base of the saw with it abutted up against the fence plate with the flip down stop located in its first position;

FIG. 15 is a top view of the fence plate;

FIG. 16 is front view of the fence plate; and

FIG. 17 is an end view of the fence plate showing the flip down stop in its two positions.

### DETAILED DESCRIPTION

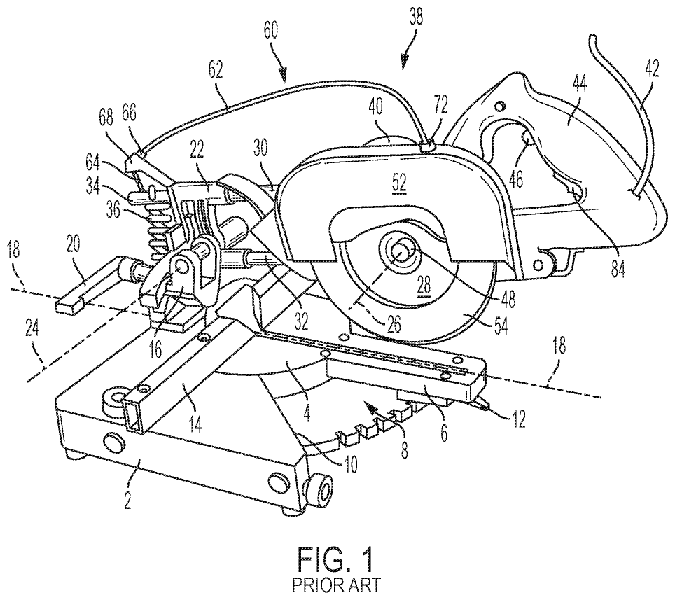

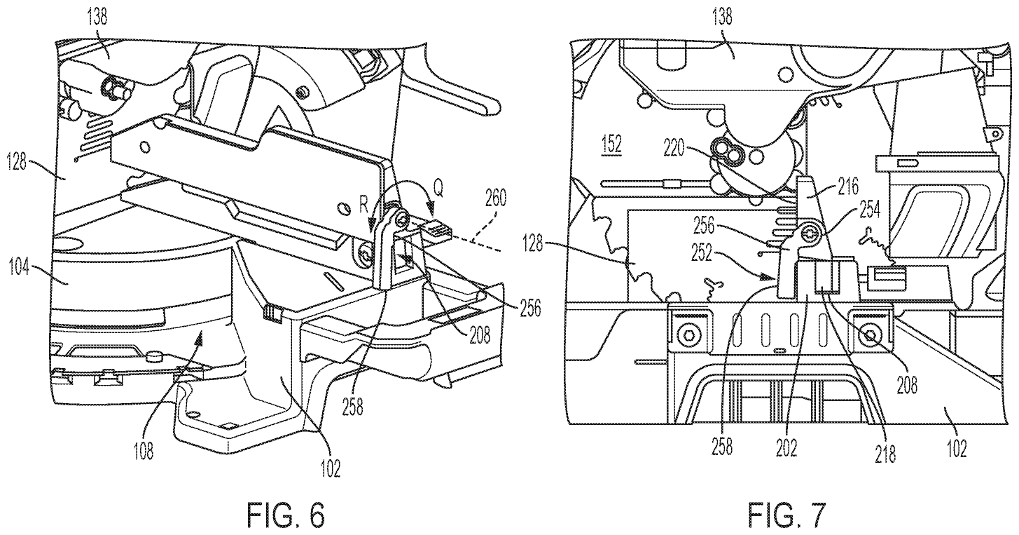

A flip down stop for a chop saw will now be described with reference to FIGS. 1-7. The general construction of saw in is similar to that described in EP1777221 and US2007/101845, all the teachings thereof being incorporated by reference.

The saw is preferably a sliding compound miter saw and may comprise a base 102 in which is mounted a circular table 104. The circular table 104 can rotate about a vertical axis. An arm 106 may be attached to the front of the circular table 104 which preferably extends through a recess 108 formed in the front of the base 102 and then forward of the base 102. As the circular table 104 rotates, the arm 106 preferably swings within the recess 108, the maximum amount of pivotal movement being limited by the sides 110 of the recess 108.

A latch (not shown) may be attached to the underside of the end of the arm which is capable of releasably locking the angular position of the arm within the recess 108. A fence assembly 114 is preferably rigidly attached to the base 102 and passes over the circular table 104.

A bevel support 116 may be pivotally attached to the rear of the circular table 104. The bevel support 116 can pivot about a horizontal bevel axis. The bevel support 116 can be locked in a range of angular positions relative to the circular table 104 using a locking handle 120.

Pivotally mounted onto the bevel support 116 is a slide support 22. The slide support 22 can pivot about a chopping axis which is parallel to the axis of rotation of a cutting blade 128.

Rigidly mounted within the slide support 22 are the ends of two straight rods 30. The rods 30 are prevented from sliding or rotating within the slide support 33. The rods 30 are preferably located one above the other and are parallel to each other. A spring 36 may be attached to the end of the top rod 30. The other end of the spring 36 is preferably attached to the bevel support 116. The spring 36 is preferably under tension, biasing the end of the top rod 30 downwardly, preferably biasing the ends of the two rods 30 located remotely from the slide support 116 upwardly due to the pivotal connection of the slide support 22 to the bevel support 116.

A saw assembly 138 may be slideably mounted onto the two rods 30. The saw assembly 138 comprises a motor housing 40 in which is mounted an electric motor (not shown). The electric motor (not shown) is preferably powered via an electric cable. Preferably mounted on the front of the motor housing 40 is a handle 44.

A trigger switch 84 is preferably mounted within the handle 44, which when depressed, activates the motor. A drive spindle 48 preferably projects from the housing 40. The circular saw blade 128 may be rigidly mounted onto the drive spindle 48. When the motor is activated, the drive spindle 48 rotates, rotatingly driving the saw blade 128.

A fixed guard 152 may be rigidly mounted onto the motor housing 40 and preferably surrounds the top cutting edge of the saw blade 128. A pivotal guard 154 may be pivotally mounted on the motor housing 40 and can pivot about the axis of rotation of the saw blade 128. The pivotal guard 154 can pivot between an enclosed position where it surrounds the lower cutting edge of the saw blade 128 and a retracted position where it exposes the lower cutting edge of the saw blade 128. When the pivotal guard is in the retracted position, it is preferably telescopically pivoted into the fixed guard 152. A pivotal guard spring (not shown) preferably biases the pivotal guard 154 to the enclosed position.

The saw assembly 138 can slide along the two rods 30 towards or away from the slide support.

In use, a work piece is preferably placed on the base 102 and circular table 104 against the fence assembly 114. The pivotal movement of the circular table 104 about the vertical axis allows the saw to perform miter cuts on the work piece. The pivotal movement of the bevel support 116 in relation to the circular table 104 about the bevel axis allows the saw to perform bevel cuts on the work piece. The pivotal movement of the slide support on the bevel support 116 about the chopping axis allows the saw to perform chop cuts on the work piece. The sliding movement of the saw assembly 138 along the two rods preferably allows the saw to perform sliding cuts on the work piece.

The saw preferably comprises a pivotal guard actuating mechanism. The pivotal guard actuating mechanism preferably causes the pivotal guard to pivot to its retracted position when the saw assembly 138 is pivoted about the chopping axis from its upper position to its lower position. The spring 36 preferably biases the saw assembly 138 to pivot about the chopping axis to its upper most position. In this position, the pivotal guard 154 preferably encloses the lower edge of the cutting blade 128. As the saw assembly 138 is pivoted downwardly towards the circular table 104, the pivotal guard actuating mechanism preferably causes the guard 154 to retract into the fixed guard 152, exposing the lower cutting edge of the blade 128.

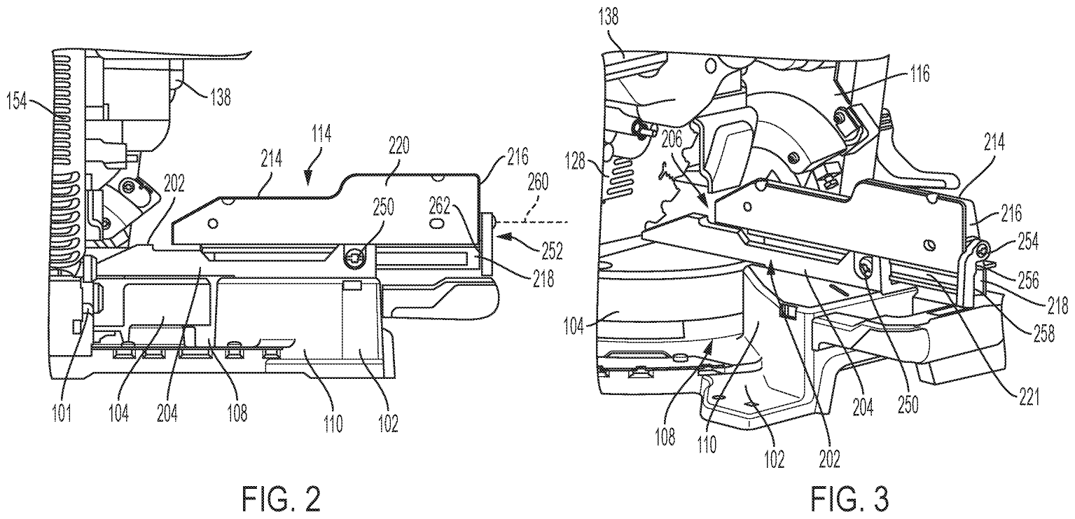

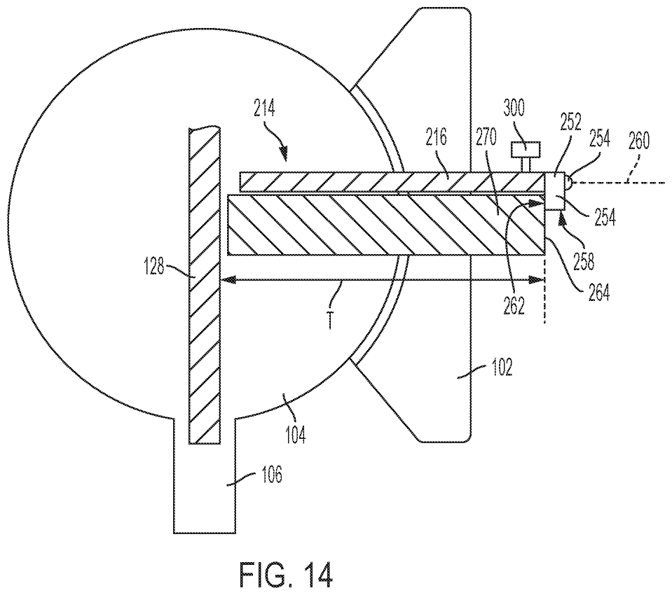

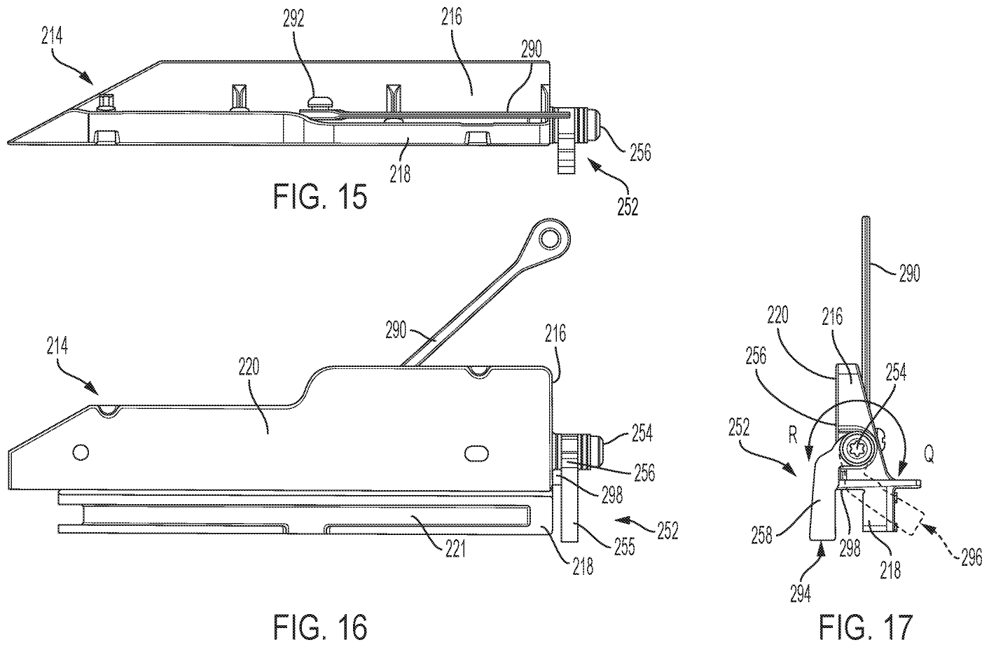

The fence assembly 114 and flip down stop 252 will now be described with reference to FIGS. 2-7 and FIGS. 14-17. The fence assembly 114 preferably comprises two fence assemblies 114 connected to each other by a semi-circular connecting part 114C (FIG. 1) in a well-known manner. Each fence assembly 114 is the same design as the other but in a mirror image. One fence assembly 114 is preferably mounted on one side of the blade 128, the other is mounted on the other side in a mirror image, with the semi-circular connecting part 114C wrapping around the rear of the blade 128. Persons skilled in the art shall recognize that only one sliding fence is shown in FIGS. 2-7.

Each fence assembly 114 preferably comprises a fence base 202 which is attached to the base 102 of the saw at one end and to the semi-circular connecting part 114C at the other. The bases 202 of the two fences assemblies 114 and semi-circular connecting part 114C are preferably manufactured from metal in a one-piece construction.

The fence base 202 may comprise a vertical flat support surface 204 formed on a front surface. The fence base 202 acts as a fixed fence, the work piece being cut being placed against the flat vertical support surface 204 of the fence base 202.

A groove 206 is preferably formed in the top of fence base 202 in a lengthwise direction. Groove 206 preferably has a uniform rectangular cross-sectional shape along its length. The end 208 of the groove 206 is open at the end of the fence base 102. A threaded hole 210 is preferably formed in the fence base 202 through the rearward side wall 212 of the groove 206 into which a shaft 304 of a lock knob 300 can be inserted. A detailed description of the stop knob 300 is provided below. A second threaded hole may be formed through the front side wall 213 of the groove 206 into which a shaft of a bolt 250 can be inserted.

A fence plate 214 is preferably mounted on the fence base 202. The fence plate 214 can slide along the groove 206 of the fence base 202 in a longitudinal direction. The fence plate 214 is preferably attached to the fence base 202 using a plastic lanyard 290. One end of the lanyard 290 may be attached to the fence plate 214 using bolt 292. The other end of the lanyard may be attached to the fence base 202 using a second bolt (not shown). The length of the lanyard 290 is such that it preferably does not interfere with the sliding movement of the fence plate 214 on the fence base 202.

The fence plate 214 preferably comprises an upper wall section 216 and a lower groove engagement section 218. The upper wall section 216 may comprise a flat support surface 220 formed on a front surface which, when the fence plate 214 is mounted on the fence base 202, preferably aligns with and is parallel to the vertical flat support surface 204 of the fence base 202. The upper wall section 216 preferably acts as a moveable fence, the flat support surface 220 co-operating with the vertical support surface 204 of the fence base 102, the work piece being cut being placed against the flat support surfaces 204, 220 of the upper wall section 216 and the fence base 202.

The lower groove engagement section 218 may comprise an elongate ridge which has a rectangular cross-sectional shape which is preferably uniform along its length and which corresponds to that of the groove 206. When the fence plate 214 is mounted on the fence base 202, the lower groove engagement section 218 preferably locates within the groove 206 of the fence base 202. An elongate recess 221 is preferably formed along the front side of the lower groove engagement section 218 and preferably extends along the front side of the lower groove engagement section 218 in a lengthwise direction. The elongate recess 221 preferably faces the exit of the second threaded hole so that, when the bolt 250 is screwed into the second threaded hole, the end of the shaft of the bolt 250 locates inside of the elongate recess 221. The bolt 250 preferably limits the amount of sliding movement of the fence plate 214 on the fence base 202, the distance being limited to amount the shaft of the bolt 250 can slide along the recess 221. The head of the bolt 250 is preferably located behind the vertical flat support surface 204 of the fence base 202 so that it does not interfere with the operation of the vertical flat support surface 204.

It will be appreciated that the bolt 250 can be omitted from the fence base 202. This would allow the fence plate 214 to slide an unrestricted distance on the fence base 202.

A flip down stop 252 is preferably pivotally mounted on the end of the upper wall section 216 of the fence plate 214 which is remote from the blade 128. The flip down stop 252 may be attached using a bolt 254 which screws into a threaded hole in the end of the upper wall section 216. The flip down stop 252 preferably comprises a first section 256 which extends radially away from the axis of pivot and a second section 258 which connects to the end of the first section remote from the axis of pivot at an oblique angle to that of the first section 254.

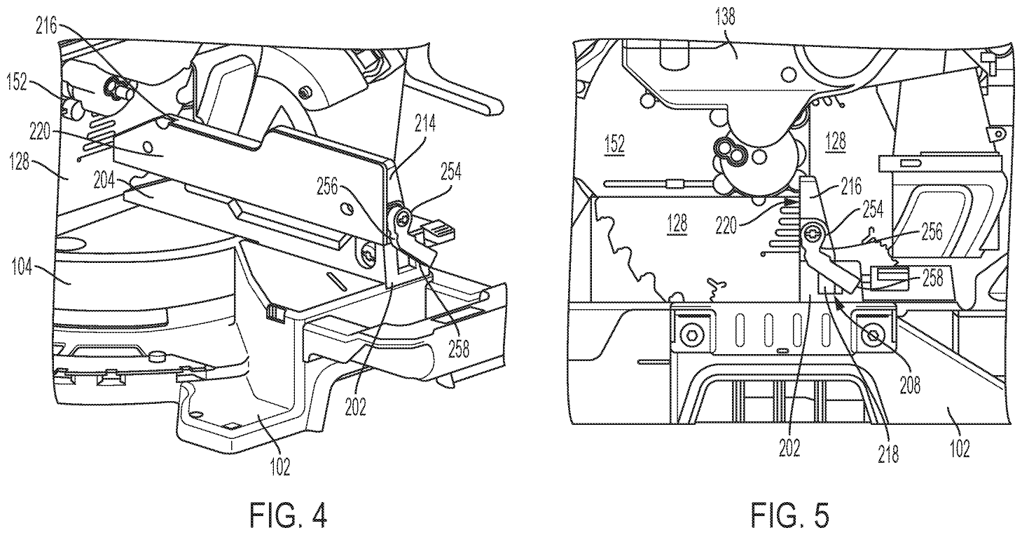

The flip down stop 252 can preferably pivot about a horizontal axis 260 which extends in a direction to the longitudinal axis of the groove 206 between two positions: a first position indicated by reference number 294 in FIG. 17 where the second section 258 is located in front of the flat support surface 220 of the upper wall section (see also FIGS. 2, 3, 6 and 7) and a second position shown by dashed lines and indicated by reference number 296 in FIG. 17 where the whole of the flip down stop 252 is located behind the flat support surface 220 of the upper wall section 216 (see also FIGS. 4 and 5). The flip down stop 252 can preferably pivot through an angle 240 degrees between its two positions.

When the flip down stop 252 is in its first position 294, the first section 256 preferably extends downwardly and forwardly at an angle from the pivot point to a position forward of the flat support surface 220 of the upper wall section 216. The second section 258 is located forward of the flat support surface 220 of the upper wall section 216 and extends vertically downwardly from the end of the first section 256. The lower end of the second section 258 preferably locates below the lower groove engagement section 218 of the fence plate 214. In the first position, the side wall 262 of the stop 252 may be located perpendicular to the plane of the support surface 220. The side wall 262 of the moveable stop is also preferably located adjacent the outer edge of the support surface which is remote from the cutting blade.

When the flip down stop 252 is in its second position 296, the first section 256 preferably extends vertically downwardly from the pivot axis 260. The second section 258 may extend downwardly and rearwardly at an angle from the vertical to a position behind the flat support surface 220 of the upper wall section 216. The lower end of the second section preferably locates at the same height as the lower surface of the lower groove engagement section 218 of the fence plate 214.

The flip down stop 254 preferably pivots from its first position 294 to its second position 296 in the direction of arrow Q and from its second position 296 to its first position 294 in the direction of arrow R. The amount of pivotal movement of the flip down stop 252 may be limited by a stop 298 formed on the end of the upper wall section 216. Friction between the flip down stop 252 and the fence plate 214 preferably holds the flip down stop 252 in its first and second positions 294, 296 against the stop 298. Friction can also hold the flip down stop 252 in any angular position between the first and second position 294, 296.

The flip down stop 252 can be used to cut workpieces to a pre-set length. When the flip down stop 252 is in its second position, it is preferably located behind the flat support surface 220 of the fence plate 214. Therefore, it is unbale to come into contact with a workpiece 270. The saw can then be used in the normal manner. However, when the flip down stop 252 is moved to its first position, it can be used to align the position of a workpiece 270 relative to the saw blade in order for it to be cut to a pre-set length.

When the lower groove engagement section 218 locates within the groove 206 of the fence base 202, the fence plate's position can be locked relative to the fence base 202 by screwing the lock knob 300 so that the end of the shaft 304 engages with the rear side of the lower groove engagement section 218 and presses it against the front wall 214 of the groove 206. The lower groove engagement section 218 then held stationary within the groove 206 of the fence base 202 due to friction. The fence plates's position can be changed by unscrewing the lock knob 300 so the end of the shaft disengages from the lower groove engagement section 218. The fence plate can then be slid along the groove 206 to a desired position.

In order to use the flip down stop 252 to cut workpieces at a pre-set length, the flip down stop 252 is pivoted to its first position. The lock knob 300 is unscrewed so that the end of the shaft 304 preferably disengages from the lower groove engagement section 218 to allow the fence plate 214 to be slid within the groove 206 on the fence base 202. The fence plate 214 is then slid within the groove 206 until the inner side wall 262 of the flip down stop 252 is located at a desired distance T from the cutting blade 128. The position at distance T can be determined using a ruler. The lock knob 300 can then be screwed into the threaded hole 210 until the end of the shaft 304 engages with the rear side of the lower groove engagement section 218 and presses it against the front wall 213 of the groove 206 to frictionally lock it to the fence base 202. The workpiece 270 is then placed on the base 102 of the saw with its side abutting the two support surfaces 204, 220 of the fence 214 and its end 264 abutting the inner side wall 262 of the flip down stop 252. The work piece 270 is then cut with the blade 128 whilst being held in this position. The workpiece 270 is then cut to a length of T. The cut workpiece 270 is then removed and another workpiece 270 placed in the same position in order for it be cut to a length T. This process can be repeated as many times as necessary.

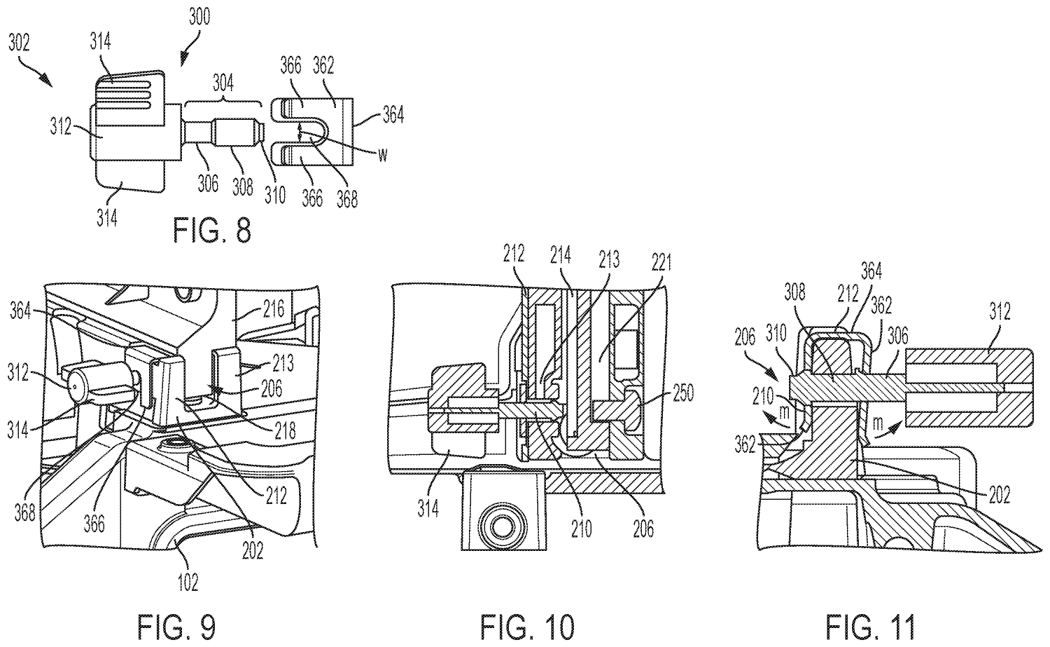

The design of the lock knob 300 will now be described with reference to FIGS. 8 to 11. The lock knob 300 preferably comprises a hand grip 302 connected to a metal shaft 304. The shaft may have three sections; a first section 306 which is preferably circular in cross-section with a pre-set diameter D1, a second section 308 which is preferably circular in cross-section with a second pre-set diameter D2, which may be greater than D1, and a third end section 310 with the same diameter D1 as the first section 306.

The second section 308 is preferably threaded and can be screwed into the threaded hole 210. The length of the second section is preferably substantially less than the length of the threaded hole 210. The hand grip 302 may comprise a central section 312 which surrounds the end of the first section 306 of the shaft 304 which is remote from the second section 308, and two wings 314 which project radially from the central section 312 in opposite directions. An operator presses the wings 314 with his fingers in order to rotate the lock knob 300.

In use, the shaft of the lock knob 300 is preferably inserted into the threaded hole 210 until the thread of the second section 308 engages with the thread of the hole 210. The knob 300 is then rotated to screw the second section 308 into the threaded hole 210. The shaft 304 can be screwed between a first position where the end section 310 has passed through the threaded hole 210 and extends into the groove 206 and a second position where the end section 310 is located within the threaded hole 210. When the shaft 210 is in its second position, the lower groove engagement section 218 can placed in the groove 206. The shaft 304 can then be screwed to its second position so that the end section 310 enters the groove 206. The shaft 304 can be rotated until end of the end section 310 engages with the side of the groove engagement section 218 of the fence plate 214. When the end is engaged with the lower groove engagement section 218, the lower groove engagement section 218 is locked into the groove 206 of the fence base 202 and is prevented from moving relative to the fence base 202.

The shaft 304 of the lock knob 300 is preferably locked into the threaded hole 210 by a clip 360. The clip 360 prevents the shaft 304 from being removed from the threaded hole 210.

The clip 360 may have two approximately parallel side sections 362 which are preferably connected to the other end at one end by a central bridging section 364 which extends perpendicularly to the side sections 362. The clip 360 is preferably formed from resilient deformable metal so that the free ends of the side sections 362 can be bent away from each other in the direction of arrow M when a force is applied but will return to their original shape and position when the force is removed due to the resilient nature of the clip 360. Each side section 362 preferably comprises two legs 366 which are separated by a gap 368 having width W along its length. The size of the width W is preferably greater than the diameter D1 of the first section 306 of the shaft 304 of the lock knob 300 but less than the diameter D2 of the second section 308 of the lock knob 300. The width of the central section 364 is approximately the same as that of the rear wall 212 of the fence base 202 which forms the rear side wall 212 of the groove 206.

When the second section 308 of the shaft of the lock knob is fully located inside of the threaded hole 210, the clip 360 is preferably slid over the rear wall 212 so that one side section 362 slides down one side of the rear wall 212, whilst the other side section slides down the opposite side of the rear wall 212 with the central bridging section 364 locating against the top surface of the rear wall 212. The resilient nature of clip 360 results in the sides of the side sections 362 pressing against the sides of the rear wall 212 to frictionally hold the clip 360 in place. When the clip 360 is slid into position, the first section 306 of the shaft 304 of the lock knob preferably locates in and passes through the gap 368 between the legs 366 of one side section 362 of the clip 360 whilst the third end section 310 of the shaft 304 of the lock knob 300 locates in and passes through the gap 368 between the legs 366 of the other side section 362 of the clip 360. This results in the second section 308 of the shaft 304 of the lock knob 300 being located between the two side sections 362 of the clip 360. As the diameter D2 of the section 308 of the shaft 304 is greater than the width W of the gap 368, it is unable to pass through the gap and therefore is prevented from exiting the threaded hole 210 by the clip 360. As such the lock knob 300 is retained in the hole 210 whilst the clip 360 remains in place. The thickness of the side section 362 of the clip is sufficiently thin so as not to interfere with the sliding operation of the lower groove engagement section 218 in the groove 206.

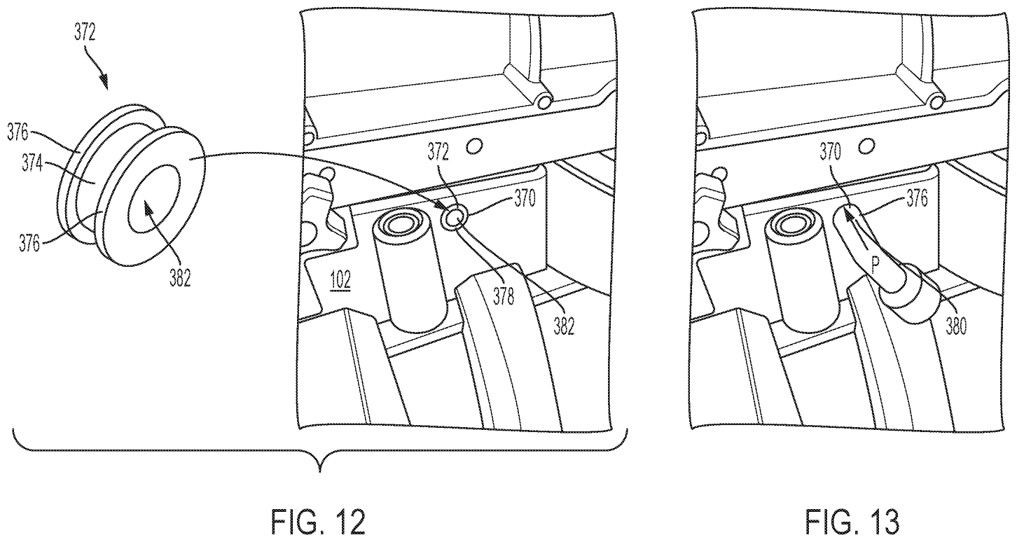

A tool holder will now be described with reference to FIGS. 12 and 13. A wall 370 preferably forms part of the base 102 of the saw which is made from sheet metal. A hole 378 is preferably formed through wall 370. A rubber grommet 372 may comprise a central tubular section 374 with radial flanges 376 formed at each end. A passage 382 preferably extends through the length of the grommet 372. The rubber grommet 372 may be formed in a one-piece construction. The grommet 372 is preferably located in the hole 378 so that one radial flange 376 locates on one side of the wall 370 and surrounds one entry into the hole 378 whilst the other radial flange 376 locates on the other side of the wall 370 and surrounds the other entry into the hole 378 with the tubular section 374 locating inside of the hole 378. The shaft 380 of a tool can then be pushed in the direction of arrow P into the passage 382 in the grommet to hold the tool on the base 102.

What is claimed is:

1. A saw comprising:
a base assembly;
a saw assembly pivotally mounted on the base assembly, the saw assembling being capable of pivoting towards the base assembly to cut a work piece disposed on the base assembly;
a fence assembly extending across at least part of the base assembly, the fence assembly comprising:
a fence base;
a fence plate slidingly mounted on the fence base, the fence plate having a support surface against which the work piece can be placed when being cut; and
a moveable stop mounted on the fence plate, the movable stop being movable between first and second positions, wherein in the first position at least part of the moveable stop is located forward of the support surface, and in the second position the moveable stop is located behind the support surface.

2. A saw as claimed in claim 1 wherein the moveable stop is mounted adjacent the support surface.

3. A saw as claimed in claim 1 wherein the moveable stop is pivotable between the first and second positions.

4. A saw as claimed in claim 3 wherein the moveable stop pivots about a pivot axis which extends in a direction parallel to a longitudinal axis of a groove formed in the fence base in which the fence plate is mounted in and capable of being slid along.

5. A saw as claimed in claim 4 wherein the moveable stop comprises a first section which extends radially away from the pivot axis and a second section which connects to the first section remote from the pivot axis at an oblique angle to that of the first section.

6. A saw as claimed in claim 5 wherein, when the moveable stop is in the first position, the first section extends downwardly and forward at an angle from the pivot axis to a position forward of the support surface; and
the second section is located forward of the support surface and extends vertically downwardly from the first section.

7. A saw as claimed in claim 6 wherein the moveable stop has a side wall located perpendicular to the support surface.

8. A saw as claimed in claim 5 wherein, when the moveable stop is in the second position, the first section is located behind the support surface and extends vertically downwardly from the pivot axis; and
the second section extends from the first section downwardly and rearwardly, away from the support surface, to a position behind the support surface.

9. A saw comprising:
a base assembly;
a saw assembly pivotally mounted on the base assembly which is capable of pivoting towards the base assembly to a cut a work piece located on the base assembly;
a fence assembly extending across at least part of the base assembly, the fence assembly comprising a fence base comprising a groove, a fence plate slidingly mounted in the groove, the fence plate further comprising a support surface against which a workpiece can be placed when being cut; and
a lock knob comprising a grip and a shaft), the shaft passing through a hole formed through a side wall of the groove so the end of the shaft remote from the grip can be moved into or out of the groove.

10. A saw as claimed in claim 9 wherein the shaft comprises:
a first section located adjacent the grip having a first diameter, a second section connected to the end of the first section remote from the grip, the second section having a second diameter which is larger than the first section, and a third section connected to the second section remote from the first section having a third diameter which is smaller than the second section.

11. A saw as claimed in claim 10 further comprising a clip comprising two side sections which are connected a central bridging section, each side section comprising two legs which are separated by a gap having width W along its length, the width W being greater than the first diameter but less than the second diameter.

12. A saw as claimed in claim 11 wherein the second section is located inside of the hole.

13. A saw as claimed in claim 12 wherein the sided sections of the clip frictionally grip the side wall.

14. A saw as claimed in claim 13, wherein the legs of one side section surround the first section of the shaft and the legs of the other side section surround the third section of the shaft.
